(19) United States
(12) Patent Application Publication
(10) Pub. No.: US 2025/0108324 A1
(43) Pub. Date: Apr. 3, 2025

(54) NITROGEN PURGING SOLUTION FOR PREVENTING LEL ACCUMULATION IN ELECTRIC HEATER TERMINAL BOXES

(71) Applicant: SAUDI ARABIAN OIL COMPANY, Dhahran (SA)

(72) Inventors: Ali Amer, Hofuf (SA); Mohammad Almusaiteer, Udhailiyah (SA); Ayman Busaad, Hofuf (SA); Abdullah Alrushaydan, Hofuf (SA); Kishor Shirsat, Udhailiyah (SA); Ali Alkhalaf, Dhahran (SA)

(73) Assignee: SAUDI ARABIAN OIL COMPANY, Dhahran (SA)

(21) Appl. No.: 18/478,474

(22) Filed: Sep. 29, 2023

(51) Int. Cl. B01D 53/04; B01D 53/26

(52) U.S. Cl. CPC B01D 53/0462; B01D 53/265; B01D 2257/80; B01D 2259/40054

(57) ABSTRACT

A system for dehydrating a natural gas or other hydrocarbons. The dehydration system includes a vessel containing a bed of adsorbent particles for adsorbing water from a wet hydrocarbon stream, producing a dried hydrocarbon stream. The system also includes an electric heater having a flow line for providing a regeneration gas to the heater, heating elements for directly or indirectly electrically heating the regeneration gas, and a flow line for providing heated regeneration gas for regenerating the adsorbent to the vessel. A terminal box includes electrical connections for providing electrical energy to the heating elements. The system further includes an accumulation prevention system, including an inlet for providing purge gas to the terminal box, a purged gas outlet for receiving a purged gas from the terminal box, and a sample line. A Lower Explosion Limit detector is provided for measuring a composition of the purged gas in the sample line.

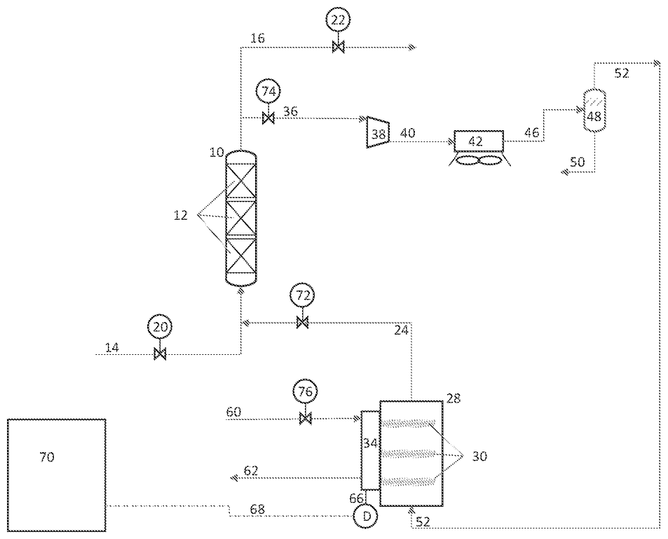

### FIELD OF THE DISCLOSURE

Embodiments of the present disclosure generally relate to electric heaters used in dehydration systems and other portions of a chemical plant.

### BACKGROUND

Electric heaters are commonly used in dehydration systems to remove moisture and other impurities from substances like natural gas and industrial chemicals. These heaters typically contain an enclosed terminal box that houses the electrical connections and wiring. However, these terminal boxes can sometimes accumulate hydrocarbons, which can create a hazardous condition known as a Lower Explosive Limit (LEL).

### SUMMARY OF THE CLAIMED EMBODIMENTS

In one aspect, embodiments disclosed herein relate to a system for dehydrating a natural gas or other hydrocarbons. The system includes a flow line to provide a wet hydrocarbon stream comprising hydrocarbons and water. A dehydration system includes a vessel containing a bed of adsorbent particles for adsorbing water from the wet hydrocarbon stream, producing a dried hydrocarbon stream having a reduced water content compared to the wet hydrocarbon stream, and a flow line is provided for conveying the dried hydrocarbon stream downstream. The system also includes an electric heater. The electric heater includes a flow line for providing a regeneration gas to the heater, heating elements for directly or indirectly electrically heating the regeneration gas producing a heated regeneration gas, and a flow line for providing the heated regeneration gas to the vessel for regenerating the adsorbent. A terminal box having electrical connections is associated with the electric heater for providing electrical energy to the heating elements. The system further includes an accumulation prevention system, including an inlet for providing a purge gas to the terminal box, a purged gas outlet for receiving a purged gas from the terminal box, and a sample line for receiving purged gas from within the terminal box or purged gas from the purged gas outlet. A Lower Explosion Limit detector may be provided for measuring a composition of the purged gas received from the terminal box or from the purged gas outlet.

Other aspects and advantages will be apparent from the following description and the appended claims.

### BRIEF DESCRIPTION OF DRAWINGS

The FIGURE illustrates a system for dehydrating hydrocarbons according to one or more embodiments disclosed herein.

### DETAILED DESCRIPTION

Embodiments herein relate to various dehydration systems that may be used to treat or otherwise prepare wet hydrocarbons prior to downstream processing or to meet pipeline specifications. “Wet hydrocarbons” as used herein refers to a vapor, liquid, or mixed vapor/liquid hydrocarbon stream that contains an excessive amount of free or dissolved water which may make the hydrocarbon stream unsuitable for downstream processing, storage, or transport in a pipeline. While the amount of water that may be considered “excessive” may vary depending upon the type of hydrocarbon, one example is natural gas. Natural gas as produced from a reservoir may be saturated with water, i.e., “wet” natural gas, and to avoid hydrate formation during processing, storage, or transport in a pipeline, it may be desirable to reduce the amount of water in the natural gas to below about 7 pounds per million standard cubic feet, for example.

The dehydration systems may include one or more techniques to remove water, including an absorbent dehydration system, which contacts a wet hydrocarbon with a solvent, such as tri-ethylene glycol (TEG), to absorb a portion of the water and produce a partially dried hydrocarbon. Membrane dehydration systems may also be used to separate a portion of the water from the wet hydrocarbon to produce a partially dried hydrocarbon. Adsorbent dehydration systems use adsorbents, such as molecular sieves or desiccants, to adsorb water contained in the hydrocarbon stream to produce a dried hydrocarbon. Embodiments herein utilize adsorbent drying systems, alone or in combination with one or both absorbent or membrane dehydration systems, to produce a dried hydrocarbon stream meeting specifications for downstream processing, storage, or transport.

The FIGURE illustrates an adsorbent dehydration system that may be used in one or more embodiments herein. The dehydration system may include a dehydration vessel 10 that contains one or more beds 12 of adsorbent particles, such as desiccants or molecular sieves. A wet hydrocarbon stream may be provided by flow line 14, such as a wet natural gas stream, may be fed to an inlet of dehydration vessel 10 and contacted with the adsorbent 12, to produce a dried hydrocarbon stream, recovered via flow line 16, having a reduced water content as compared to wet hydrocarbon stream 14. Multiple dehydration vessels 10 may be used in series to reduce water content to a desired level. Further, multiple dehydration vessels 10 may be provided in parallel to allow regeneration of spent or saturated adsorbent particles in one dehydration vessel while continuing to process wet hydrocarbons in another dehydration vessel.

Regeneration of the adsorbent may be conducted, for example, by passing a heated regeneration gas over the adsorbent particles to remove adsorbed water from the particles, thereby renewing their capacity to capture water. The regeneration gas may be air or nitrogen, in some embodiments, and the air or nitrogen may be heated using an electric heater, thereby reducing overall plant emissions associated with the hydrocarbon processing by avoiding the use of a fired heater to provide heat to the regeneration process. Electric heaters may also be used in other portions of the process.

Electric heaters that may be used according to embodiments herein may include heating elements configured to heat the regeneration gas via radiative heating, convective heating, or both radiative and convective heating. The heating elements may be disposed and arranged in a heater box, for example, to provide a tortuous path for the regeneration gas to pass over the heating elements so as to effectively heat the regeneration gas to a desired temperature.

Electrical power is distributed to the multiple heating elements within a terminal box. The terminal box generally includes a main power cable providing electrical power from a source, and electrical connections (fuses, circuitry, etc.) to distribute the electrical power to the multiple heating elements.

Unfortunately, there is a potential for hydrocarbons to migrate within the dehydration system, or from outside the system, to the terminal box, which may include exposed electrical contacts or electrical contacts with a failure in one or more of a ceramic bead insulator or a double seal system (soft seal, hard seal, such as a double epoxy seal system). Hydrocarbons present in the environment, such as in the local atmosphere, outside the terminal box, if improperly sealed, may also diffuse and accumulate within the terminal box.

Additionally, hydrocarbons being processed in the drying system itself, or hydrocarbons within other portions of the process using an electric heater, may undesirably migrate into a terminal box, such as through a crack, seal, or other leak point, that may result in hydrocarbons present within the heater box entering the terminal box. Block valves, flow control valves, and check valves that may be provided in the system and that typically restrict hydrocarbon flow into the heater box may fail, for example.

In some embodiments, the hydrocarbons that are fed to or otherwise find their way to the heater box and potentially find their way into the terminal box may be provided by a recycled regeneration gas. To decrease or minimize the amount of energy required to heat regeneration gas, for example, it may be desirable to cool and compress the wet regeneration gas to condense and remove water from the wet regeneration gas, providing a recycled stream of regeneration gas having a restored capacity to hold water. Hydrocarbons that may be present on or in the adsorbent particles, if not also condensed, may be recirculated along with the recirculating regeneration gas to the heater box.

Accumulation of hydrocarbons within a terminal box could potentially result in buildup of the hydrocarbons to a concentration that may exceed the lower explosion limit (LEL) of the hydrocarbon. Opening of the terminal box to perform maintenance, or simply presence of a flammable mixture within the box, given an ignition source, could result in a fire or explosion and consequent damage to the equipment or personnel.

To prevent such consequences, embodiments herein provide an accumulation prevention system to eliminate the potential for accumulation of hydrocarbons within the terminal box. The accumulation prevention system includes an inlet for providing a purge gas to the terminal box, a purged gas outlet for receiving a purged gas from the terminal box, and a sample line for receiving purged gas from within the terminal box or from the purged gas outlet. The accumulation prevention system further includes a detector, such as a composition analyzer or a lower explosion limit detector, for measuring a composition of the purged gas received from the terminal box or from the purged gas outlet.

A local indicator may be provided to display the analysis results, or to provide a visual or audible alarm to those in the vicinity of the terminal box. In other embodiments, a transmission line or transmitter may be provided to transmit a signal from the detector to a digital control system associated with plant operations, such as may be housed in a building and monitored by operators. The transmitted signal, or a voltage output of the detector may be representative of the composition of the purged gas, or may be indicative of the composition relative to the lower explosion limit. The digital control system may include a display device configured to display the composition of the purged gas as transmitted by the detector. The digital control system may further include an audible or visual alarm for audibly or visually signaling when the composition of the purged gas contains an amount of hydrocarbons approaching or exceeding a lower explosion limit of the hydrocarbons. The display or alarms may thus be used to ensure safety when opening the terminal box for maintenance, as well as to provide advance notice for when remedial measures may be required to avoid further accumulation of hydrocarbons within the terminal box.

Referring again to the FIGURE, a dehydration system including an electric heater for heating a regeneration gas is illustrated. During a regeneration cycle, the hydrocarbon flow, such as flow of a wet natural gas, from flow line 14 to dehydration vessel 10 may be stopped, such as via a block or control valve 20 and the flow of dried natural gas downstream via flow line 16 may be stopped via a block or control valve 22.

To regenerate the adsorbent particles in the one or more beds 12, a heated regeneration gas may be provided via flow line 24. A flow line 26 may provide a fresh or recycled regeneration gas to heater 28. Heater 28 includes one or more heating elements 30 for directly or indirectly electrically heating the regeneration gas, producing a heated regenerated gas fed via flow line 24 to the dehydration vessel 10. Heater 28 also includes a terminal box 34 comprising electrical connections (not illustrated) for providing electrical energy to heating elements 30. After passing over the adsorbent particles, the wet regeneration gas may be recovered via flow line 36.

As illustrated in the FIGURE, embodiments herein may include a regeneration gas recirculation system. The regeneration gas recirculation system may include, for example, a compressor 38 for compressing the wet regeneration gas 36 received from the dehydration vessel, producing a compressed regeneration gas 40, and a cooler 42 for reducing a temperature of the compressed wet regeneration gas 40, the cooler 42 producing a cooled regeneration gas 44. A knockout drum 48 may be provided for separating condensed water 50 from the cooled regeneration gas and to produce a recycle regeneration gas 52 having a reduced water content and a restored capacity for desorbing water from the adsorbent. Flow line 52 may then be used to return the recycle regeneration gas to an inlet of the electric heater for continued use in regenerating the adsorbent particles in beds 12.

As also illustrated in the FIGURE, the system includes an accumulation prevention system. The accumulation prevention system includes an inlet 60 for providing a purge gas to terminal box 34, as well as a purged gas outlet 62 for receiving a purged gas from terminal box 34. A sample line 66 may be provided for receiving purged gas from within the terminal box (as illustrated) or purged gas from the purged gas outlet, and the sample line may convey the purged gas to a detector D, such as a Lower Explosion Limit detector, for measuring a composition of the purged gas received from the terminal box or from the purged gas outlet. As described above, in some embodiments the detector may transmit a signal via transmission line 68 to a digital control system 70 for remote monitoring of the terminal box.

The flow of regeneration gas through vessel 10 may be controlled by one or more control valves 72, 74. Further, the flow of purge gas through the terminal box 34 may be controlled by a flow valve 76.

If desired, the purged gas outlet 62 may be fluidly connected to a flare system. The purge gas supply may be provided by a local source, such as a nitrogen tank, or may be provided by a fluid connection to a plant nitrogen or air supply system.

Embodiments herein provide a line of continuous nitrogen purging to the terminal box, which houses high-voltage resistance cable terminations. Nitrogen is an inert gas that can be used to displace oxygen and other gases in the terminal box, reducing the risk of LEL accumulation. By continuously purging the enclosed terminal box with nitrogen, the risk of hydrocarbon accumulation and LEL formation can be greatly reduced. Such can greatly reduce the risk of LEL accumulation and potential explosions, increasing the safety of the dehydration system. It can also improve the reliability and longevity of the electric heater, as it reduces the risk of damage caused by explosions or other safety issues. Embodiments herein may additionally provide an instant alert system (LEL reading) to the operating plants in case of hydrocarbon accumulation where proactive measures can be taken before subsequential incidents. The addition of the purge line is unique as it helps in protecting critical electric safety equipment and helps in increasing the lifetime of electric heaters. Embodiments herein can also be used for electric equipment that are equipped with terminal boxes with application of flammable vapors such as specified chemicals and hydrocarbons.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A system for dehydrating a natural gas or other hydrocarbons, the system comprising:
a flow line to provide a wet hydrocarbon stream comprising hydrocarbons and water;
a dehydration system comprising a vessel containing a bed of adsorbent particles for adsorbing water from the wet hydrocarbon stream, producing a dried hydrocarbon stream having a reduced water content compared to the wet hydrocarbon stream;
a flow line for conveying the dried hydrocarbon stream downstream;
an electric heater including:
a flow line for providing a regeneration gas to the heater;
heating elements for directly or indirectly electrically heating the regeneration gas producing a heated regeneration gas;
a flow line for providing the heated regeneration gas to the vessel for regenerating the adsorbent;
a terminal box comprising electrical connections for providing electrical energy to the heating elements;
an accumulation prevention system, comprising:
an inlet for providing a purge gas to the terminal box;
a purged gas outlet for receiving a purged gas from the terminal box;
a sample line for receiving purged gas from within the terminal box or purged gas from the purged gas outlet; and
a Lower Explosion Limit detector for measuring a composition of the purged gas received from the terminal box or from the purged gas outlet.

2. The system of claim 1, further comprising
a transmission line for transmitting a signal representative of the composition of the purged gas from the Lower Explosion Limit detector to a digital control system;
wherein the digital control system comprises:
a display device for displaying the composition of the purged gas; and
an audible or visual alarm indicator for audibly or visually signaling when the composition of the purged gas contains an amount of hydrocarbons approaching or exceeding a lower explosion limit of the hydrocarbons.

3. The system of claim 1, further comprising a flow control valve for maintaining a flow rate of purge gas provided to the inlet.

4. The system of claim 1, wherein the purged gas outlet is fluidly connected to a flare system.

5. The system of claim 1, wherein the purge gas inlet is fluidly connected to a plant nitrogen supply system.

6. The system of claim 1, further comprising a regeneration gas recirculation system, comprising:
a compressor for compressing wet regeneration gas received from the vessel, producing a compressed regeneration gas;
a cooler for reducing a temperature of the compressed regeneration gas and to produce a cooled regeneration gas;
a knock out drum for separating condensed water from the cooled regeneration gas and to produce a recycle regeneration gas;
a flow line for feeding the recycle regeneration gas to the regeneration gas inlet of the electric heater.
